(19) United States
(12) Patent Application Publication
(10) Pub. No.: US 2005/0167024 A1
(43) Pub. Date: Aug. 4, 2005

(54) RFID label applicator and method of application

(76) Inventors: Michael A. Sanzone, Malvern, OH (US); Gerard T. Kelly, Canfield, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/771,881

(22) Filed: Feb. 4, 2004

(51) Int. Cl. B32B 31/00; B65C 9/40; B65H 29/00

(52) U.S. Cl. 156/64; 156/556; 156/363; 156/378

(57) ABSTRACT

An automated label applicator includes a pad assembly with a radio frequency (RF) antenna mounted thereon to test radio frequency identification (RFID) labels prior to label application. A reader/writer logic board is in communication with the RF antenna to determine whether a RFID label is suitable for receiving RF information. The RF antenna writes information on suitable labels and tests label for viability of the information. The pad assembly is movably connected to a tamp assembly and defines air passages in communication with a pneumatic power source to apply viable labels via a blow method or a tamp and blow method. The tamp assembly is slidably connected to a slide mount via a slide plate and slide bars to allow the pad assembly to move between a home position where viable labels are applied to target items and a rejection position where rejected labels are disposed of on a reject label platform.

### BACKGROUND OF THE INVENTION

1. Technical Field

The invention relates to an improved label applicator. More particularly, the invention relates to a label applicator for a radio frequency identification (RFID) label. Specifically, the invention relates to a RFID label applicator having a radio frequency (RF) antenna whereby the RFID labels can be tested prior to application on an item and either rejected or applied to the item.

2. Background Information

A host of label applicators are known in the art. One type of label applicator works with a roll of pressure sensitive labels which are carried on a carrier web which is threaded through a series of rollers and then folded back on itself so that the label separates from the web and is ready for application on an item such as a box or an item of merchandise. Typically, the items on which the labels are to be applied proceed forward on a conveyor toward the point of application so that the items and labels come together in a repeated pattern in order to facilitate automated application of the labels on the items. Such labels typically have an adhesive backing and often are pressure sensitive. There are three common ways of applying the label to the item at the point of application. One of these is called “merging”, in which the label and the item move along in the same direction and come into contact with one another at the point of application. A second way of applying labels is known as “blowing”, whereby a source of pressurized air is utilized to blow the label onto the item. Typically, this is accomplished by an apparatus with a plurality of holes in it which is connected to a reversible air supply so that the label may be suctioned onto the apparatus by the air flow going in one direction and then blown onto the item by reversing the air flow. The third common type incorporates the blow aspect and is known as “tamp and blow”. Once the labels are suctioned on to the apparatus or head, the head is then moved by an actuator toward the item in order to be in closer proximity thereto and then the label is blown onto the item.

While all of these methods are suitable for automated label application, there remains a problem in regard to the use of RFID labels. In particular, the labels are not tested prior to being applied to an item. These RFID labels have transponder circuits with individual identification (ID) codes which facilitate tracking. In addition, the RFID labels can be written on by a RF antenna having a writing capability so that information particular to the item on which the labels are to be applied can be written onto the label. However, if the RFID label that is applied to the item was not properly manufactured or was damaged somehow prior to application of the label onto the item, subsequent testing to determine whether the label passes inspection requires either that the item be re-labeled or that the product be rejected. Even worse, if the item with a label thereon gets to market, then either the information on the label is not good or there is no information on the label at all and the product is deemed a reject as to the information. Because reject labels can cause a substantial amount of additional work for marketers of products so labeled, such marketers may fine label producers for reject labels. As RFID labels become more common and replace bar codes due to their greater utility, the importance of minimizing reject labels increases. Thus, there remains a need fortesting RFID labels priorto application on items to prevent the above-noted problems.

### BRIEF SUMMARY OF THE INVENTION

The present invention provides an applicator for applying RFID labels of the type having a transponder, the applicator comprising an application zone; an applicator head positioned adjacent the application zone and adapted for applying the label to a product; an antenna positioned adjacent the application zone and adapted for reading the transponder; a test circuit for receiving information from the antenna and adapted to determine if the transponder is viable; and a reject area adapted for receiving rejected labels from the applicator head if the test circuit determines that there is a non-viable transponder.

The present invention also provides a method of applying an RFID label to an item, the label having a transponder, the method comprising the steps of positioning a label adjacent an application zone; testing the label for viability adjacent the application zone; communicating the result of the test to a control circuit; allowing the control circuit to communicate with a power supply; and operating the power supply to move the label to the item if the label is viable.

The present invention further provides a method of applying an RFID label to an item, the label having a transponder, the method comprising the steps of positioning a label adjacent an application zone; testing the label for viability adjacent the application zone with an RFID antenna; and moving the label to the item if the label is viable and to a reject area if the label is non-viable.

### BRIEF DESCRIPTION OF THE SEVERAL VIEWS OF THE DRAWINGS

FIG. 1 is a side elevation view of the label applicator of the present invention.

FIG. 2 is a top plan view of the label applicator, shown in FIG. 1.

FIG. 3 is an end view of the label applicator as viewed from the right side of FIG. 1.

FIG. 4 is an end view of the pad assembly as viewed from the left of FIG. 1.

FIG. 5 is a bottom plan view of the pad assembly shown in FIG. 4.

FIG. 6 is a sectional view taken on line 6-6 of FIG. 5.

FIG. 7 is a sectional view taken on line 7-7 of FIG. 6.

FIG. 8 is a view similar to FIG. 1 except it includes the roll of labels installed on the label applicator with the carrier web threaded through the rollers on the machine and items upon which labels are to be applied.

FIG. 9 is an enlarged fragmentary view of a portion of FIG. 8 showing the pad assembly in a raised position and a label prior to separation from the carrier web.

FIG. 10 is a view similar to FIG. 9 except showing the label partially separated from the web and partially beneath the pad assembly, which is in the raised position.

FIG. 11 is a view similar to FIG. 10 except with the label fully separated from the web and disposed beneath the pad assembly, which is in the raised position.

FIG. 12 is similar to FIG. 6 and additionally shows the direction of air flow through passageways in the pad assembly and the label being held to the pad by suction.

FIG. 13 is a view similar to FIG. 11 except with the pad assembly in a lowered position and the label applied to an item below the pad assembly.

FIG. 14 is a view similar to FIG. 12 but showing the air flow in a reverse direction so as to blow the label away from the pad and onto the item.

FIG. 15 is a view similar to FIG. 13 except with the pad assembly returned to the raised position and the item with the applied label moving away from the pad.

FIG. 16 is a view similar to FIG. 11 showing a second embodiment of label application without the use of tamping or lowering of the pad assembly.

FIG. 17 is a view similar to FIG. 16 with the label being blown onto the item while the pad assembly remains in the raised position.

FIG. 18 is a view similar to FIG. 14 except the pad assembly is in the raised position with the label being blown down onto the item from that position.

FIG. 19 is an enlarged fragmentary view of FIG. 3 with the pad assembly in a raised home position with a reject label held on the pad by suction and the reject label platform with rejected labels disposed thereon.

FIG. 20 is a view similar to FIG. 19 except with the pad assembly moved to a rejection position and a label being blown onto the reject label platform.

FIG. 21 is an enlarged fragmentary top plan view showing the reject label platform and the pad assembly and tamp assembly returned to the home position.

### DETAILED DESCRIPTION OF THE INVENTION

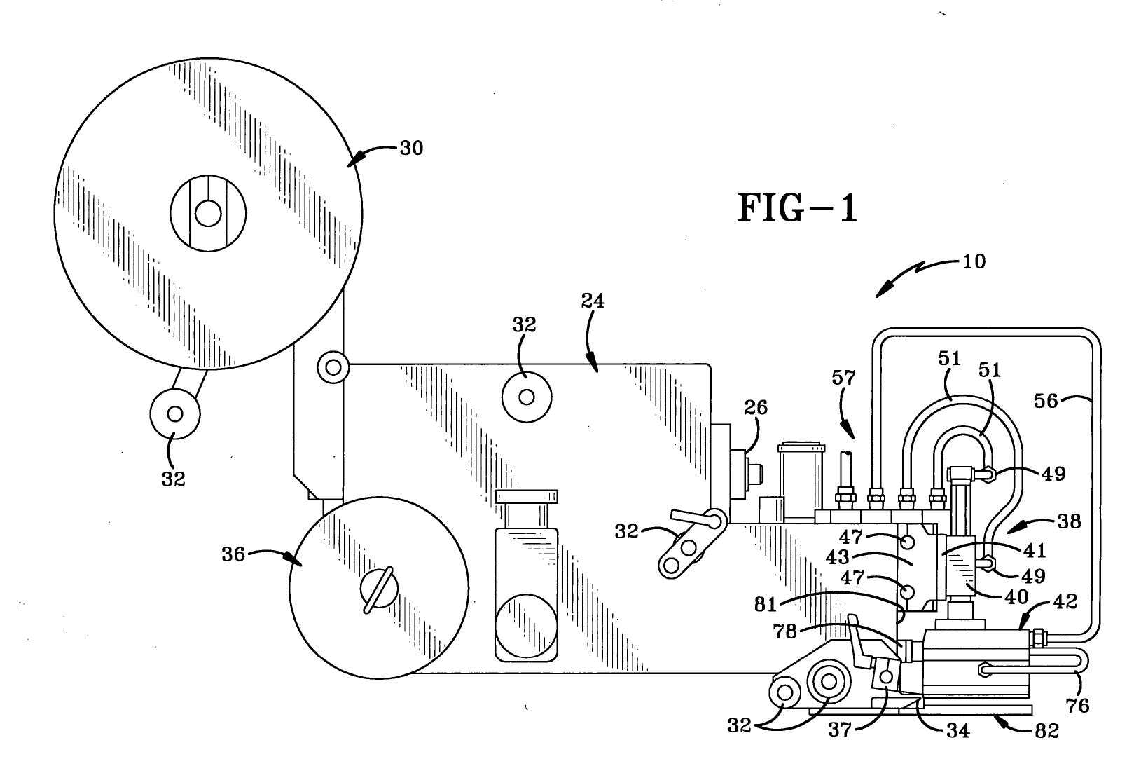

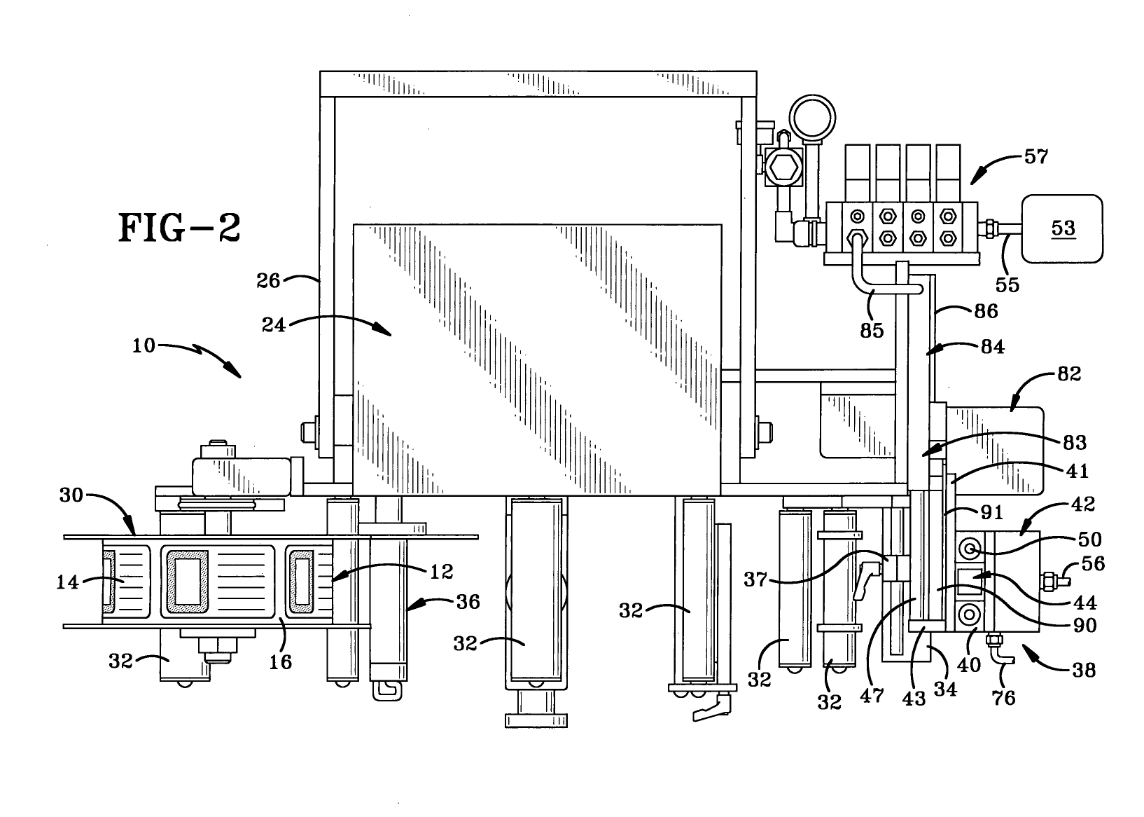

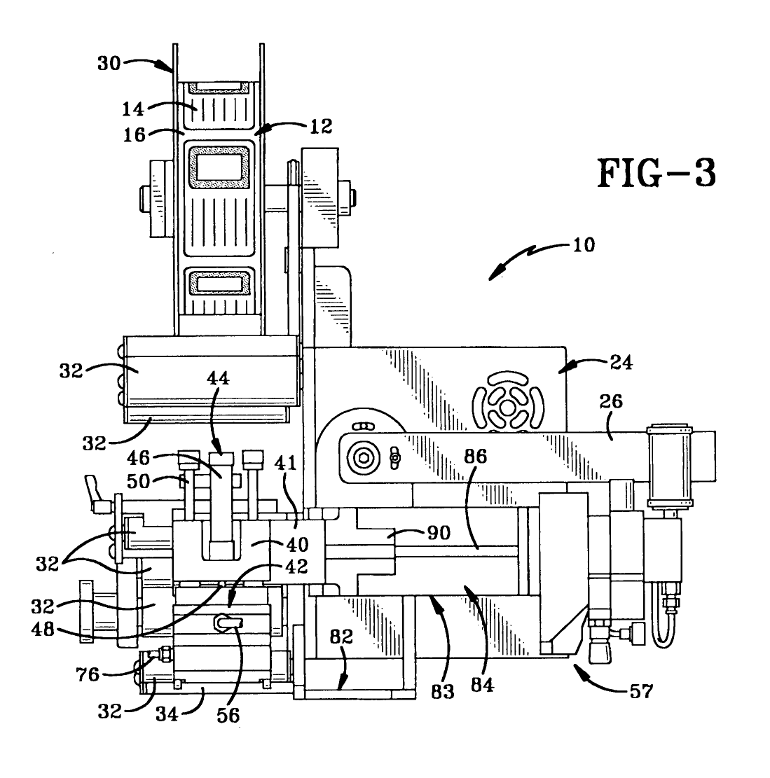

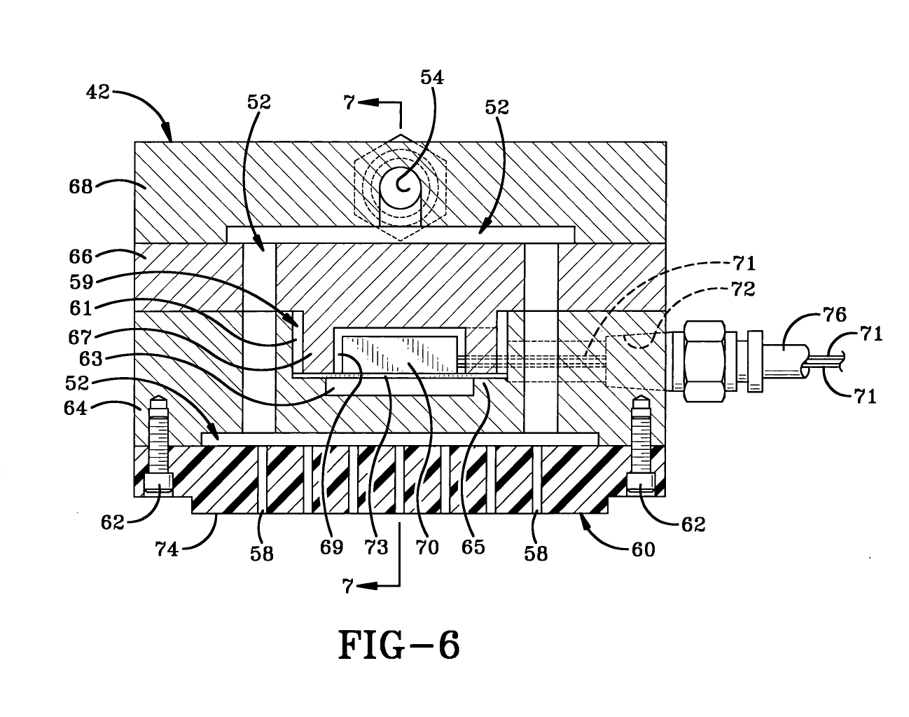

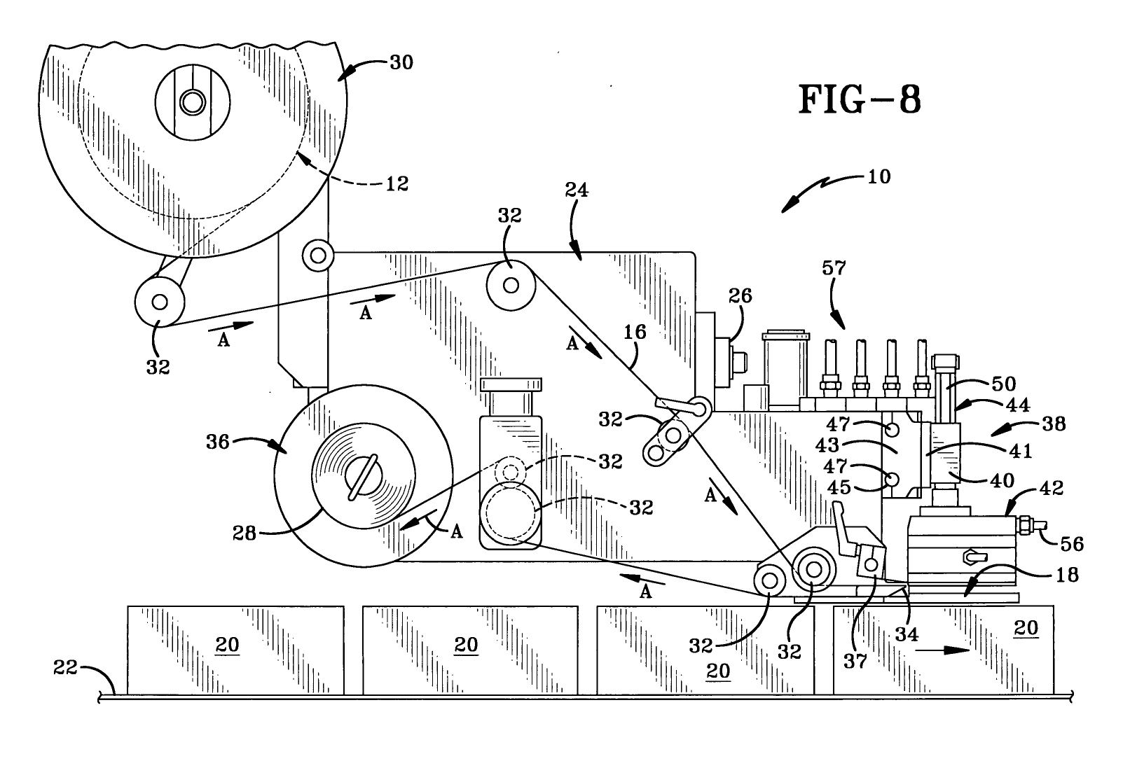

A label applicator of the present invention is indicated generally at 10 and is shown particularly in FIGS. 1-8. Label applicator 10 is configured to support a roll 12 of labels 14 (FIGS. 3 and 8) on a carrier web 16 and carry labels 14 to an application zone 18 in order to apply labels 14 on respective items 20 which are typically carried on a conveyor belt 22, although means for conveying items 20 may vary. In particular, labels 14 are RFID labels which applicator 10 tests prior to application of labels 14 on items 20. Each RFID label 14 includes an integrated transponder circuit (or transponder) that can be read, programmed (written on), and re-programmed (re-written or written over) via radio waves. In many cases, the transponder is written on once and read many times, for instance, as a product with RFID label 14 moves through the stream of commerce and information on the transponder needs to be read at various stages of its journey. Each transponder is individually coded with a distinct ID code.

Referring to FIGS. 1-3, applicator 10 includes a frame 24 which is pivotally mounted to a U-shaped mount 26. On frame 24 are mounted a series of members configured to guide carrier web 16 from roll 12 to application zone 18 to deliver labels 14 to zone 18 and to guide the web to be rewound onto a rewind assembly 36. In particular, an unwind assembly 30 unwindingly supports roll 12 from which carrier web 16 is guided around a series of rollers 32 and a peel edge 34 where labels 14 are peeled off of carrier web 16 as web 16 is folded sharply backward. Web 16 continues beyond peel edge 34 through additional rollers 32 and on to a rewind assembly 36 to form a rewind roll 28 (FIG. 8). A spring clip 37 is provided adjacent peel edge 34 to adjust the tension of carrier web 16 to ensure labels 14 properly peel off of web 16.

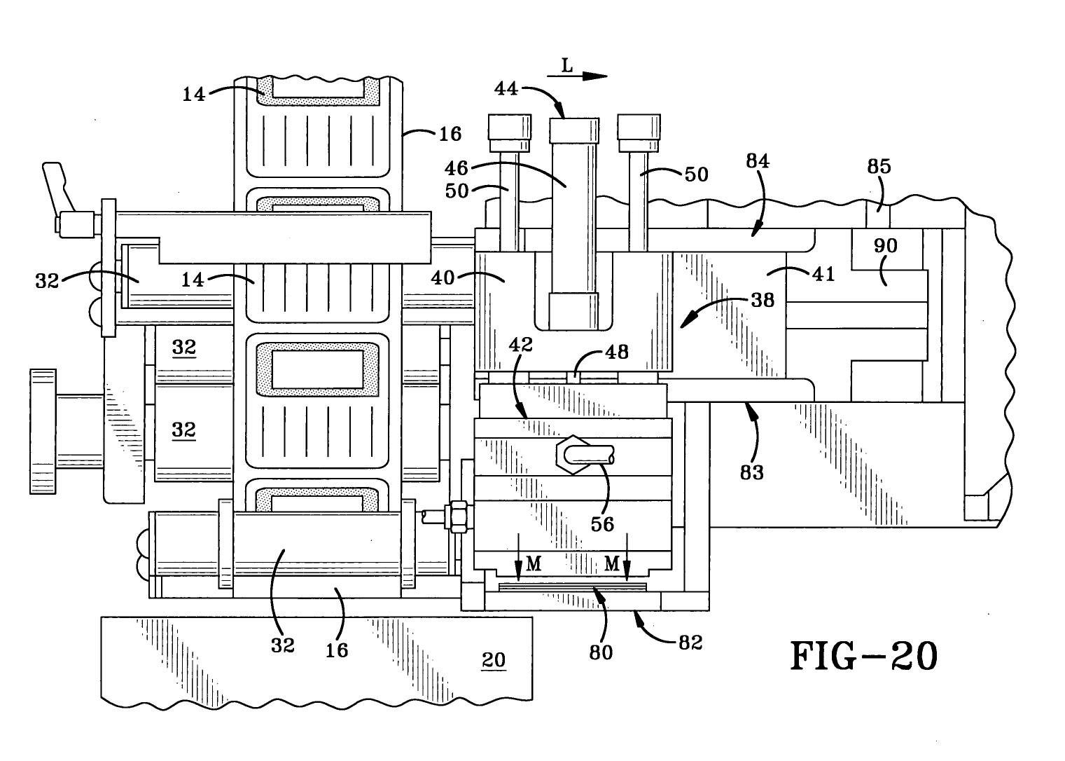

A tamp assembly 38 includes a mounting member 40 rigidly mounted on a mounting plate 41, which is rigidly mounted on a slide assembly 83 at an end plate 43 and a slide plate 90. Assembly 83 is detailed further below. A pad assembly 42 is rigidly mounted to a lower end of tamp assembly 38. With reference to FIGS. 3 and 19, tamp assembly 38 includes a piston-cylinder combination 44 which includes a cylinder 46 with a piston rod 48 extending downwardly therefrom (FIG. 3). Combination 44 is pneumatically connected to a valve bank assembly 57 via connectors 49 and conduits 51. Tamp assembly 38 further includes a pair of vertically elongated guide bars 50 disposed on either side of cylinder 44. Mounting member 40 defines holes (not shown) through which piston rod 48 and guide bars 50 slidingly extend. Piston rod 48 and guide bars 50 are rigidly mounted to pad assembly 42. Tamp assembly 38 thus provides slidable vertical movement of assembly 38 and pad assembly 42.

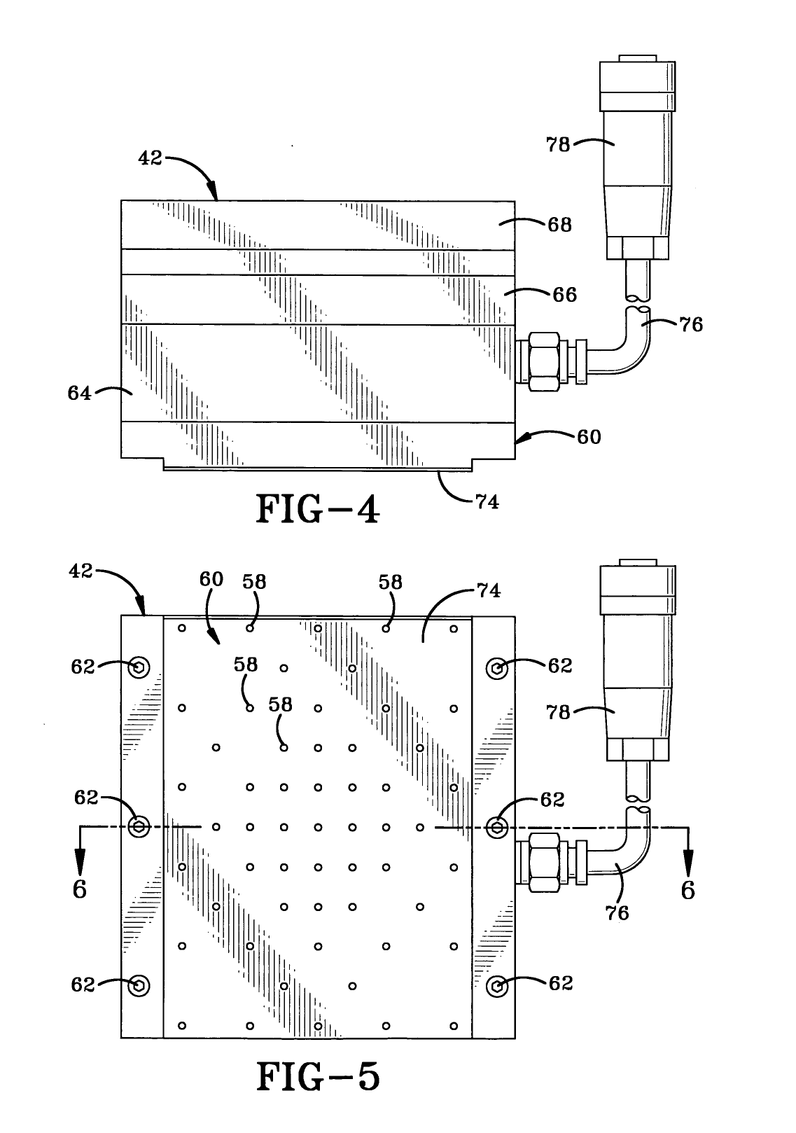

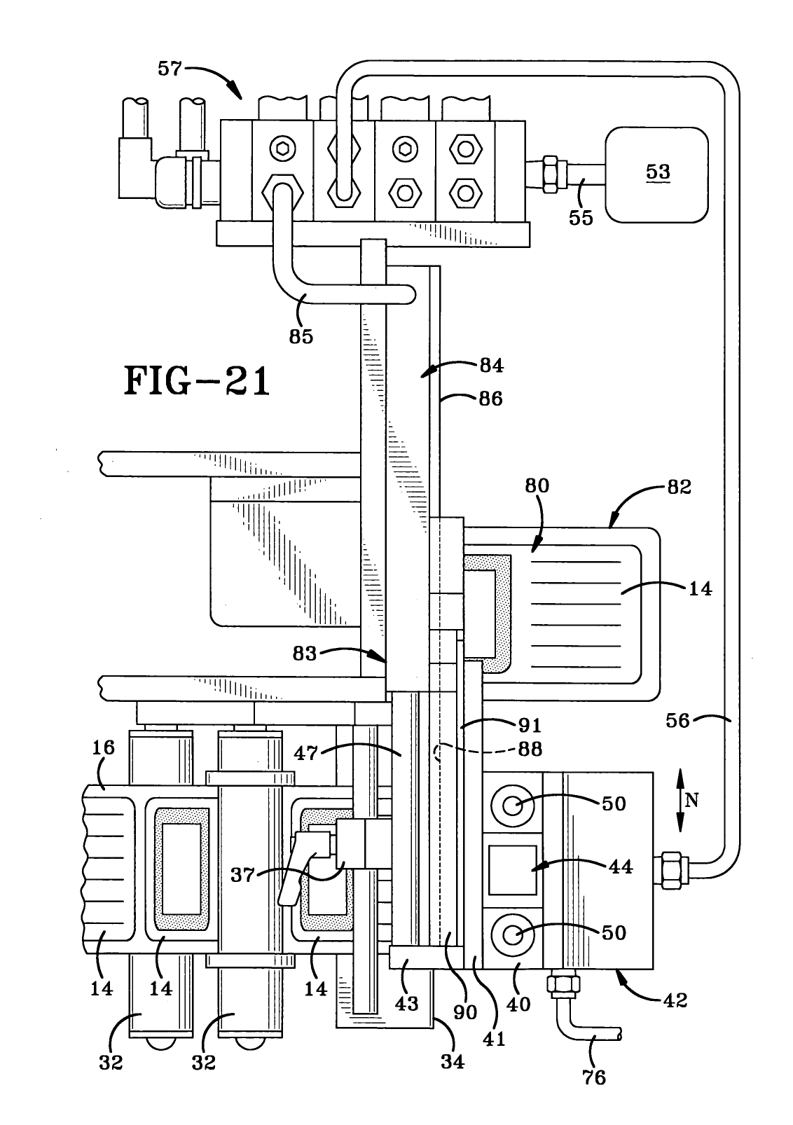

With reference to FIGS. 4-7, pad assembly 42 is further detailed. Pad assembly 42 is a head defining a series of channels or passages 52 in communication with a source 53 of compressed air via conduit 55 (FIG. 21) so that air enters and exits through an air inlet 54 via a conduit 56. Conduit 56 is connected to valve bank assembly 57 to control the air flow from source 53 to air inlet 54 and passageways 52. Air passages 52 include a plurality of air holes 58 formed in a label pad 60, which is the lowermost portion of pad assembly 42. Label pad 60 is connected by bolts 62 to an antenna container section 64 disposed above label pad 60. Pad assembly 42 further includes an antenna hold-down section 66 to which antenna container section 64 is connected and a manifold section 68 to which antenna hold-down section 66 is connected. Air inlet 54 is formed in manifold section 68. Antenna container section 64 surrounds and defines an outer antenna chamber 59 extending downwardly therein. Chamber 59 includes an upper portion 61 stepped down to a smaller lower portion 63 via a support ledge 65. Antenna hold-down section 66 includes a downwardly extending interior perimeter wall 67 defining an inner antenna chamber 69 there within. When pad assembly 42 is assembled, chamber 69 is disposed within upper portion 61 of outer chamber 59 and above lower portion 63.

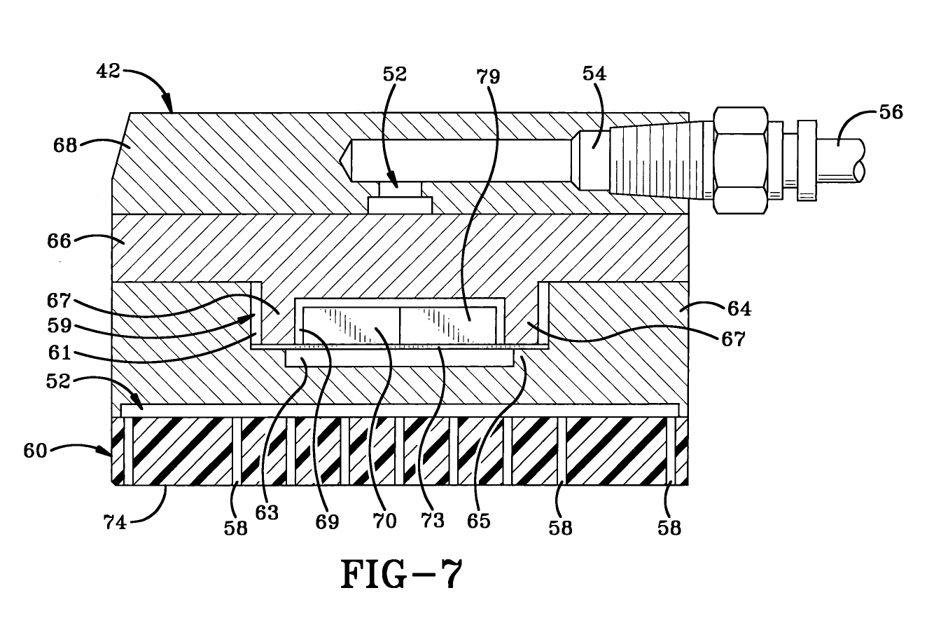

In accordance with one of the main features of the invention, and with reference to FIGS. 6-7, an RF antenna 70 having a mounting plate 73 is mounted on pad assembly 42 so that it is disposed within pad assembly 42. An RFID reader/writer 79 (FIG. 7) having a logic board with a test circuit is also mounted on mounting plate 73 adjacent antenna 70 and is in communication with antenna 70. More particularly, antenna 70 and reader/writer 79 are disposed within inner antenna chamber 69 with mounting plate 73 adjacent an outer perimeter thereof sitting atop support ledge 65. Interior wall 67 of hold-down section 66 sits atop mounting plate 73 adjacent the outer perimeter thereof. Plate 73 is thus clamped between wall 67 and ledge 65 to hold antenna 70 and reader/writer 79 in place so that antenna 70 is properly positioned with regard to RFID labels 14 as labels 14 are held to label pad 60 at a lower surface 74 thereof, as further described hereafter. Reader/writer 79 is connected to wires 71 which pass through a hole 72 formed in section 64 and through a tube 76 which is connected to antenna container section 64, being inserted within hole 72 thereof. Distal pad assembly 42, tube 76 and wires 71 there within are connected to a connector 78 which is connected at a side panel 81 of label applicator 10 so that reader/writer 79 is in communication with various controls for operating applicator 10 to respectively apply label 14, reject label 14 and advance carrier web 16 and conveyor belt 22 with items 22 thereon toward application zone 18. The logic board test circuit of reader/writer 79 determines the viability of the transponder on label 14 and the viability of any information written to the transponder, as further discussed below.

In accordance with another one of the main features of the invention, and with reference to FIGS. 19-21, pad assembly 42 and tamp assembly 38 are movable between a home position (FIG. 19) above application zone 18 and a rejection position (FIG. 20) above a rejection location 80 atop a reject label platform 82. Movement between the home and rejection positions is achieved by slide assembly 83. The slide assembly 83 shown in the exemplary embodiment is a cantilever slide (Series STP) available from PHD, Inc. in Fort Wayne, Ind., although any suitable sliding mechanism may be used in its place. More particularly, pad assembly 42 and tamp assembly 38 are slid ably mounted to a stationary slide mount 84 of assembly 83. Slide mount 84 is rigidly mounted to frame 24 and includes an outwardly projecting elongated horizontal key 86 slidably received within a key way 88 formed in a slide plate 90. Slide plate 90 includes a flange portion 91 (FIG. 21) formed integrally therewith. As noted earlier, tamp assembly 38 is mounted via mounting member 40 to mounting plate 41, which is mounted on slide plate 90 and end plate 43. End plate 43 defines a pair of holes 45 for mounting on a respective pair of slid able guide bars 47 adjacent respective ends thereof. Guide bars 47 are slidingly received within apertures (not shown) formed in slide mount 84. Slide assembly 83 is pneumatically actuated by source 53 via conduit 55, valve bank assembly 57 and a conduit 85 (FIG. 21).

In operation, label applicator 10 functions as follows with reference to FIGS. 8-21. With reference to FIG. 8, roll 12 of RFID labels 14 is mounted on unwind assembly 30 and carrier web 16 with labels 14 thereon is threaded around various rollers 32 and peel edge 34 as previously described and ultimately onto rewind assembly 36 whereby during operation of applicator 10 carrier web 16 forms rewind roll 28. Carrier web 16 travels in the direction of Arrows labeled A in FIG. 8 and thus carries labels 14 toward peel edge 34 and application zone 18.

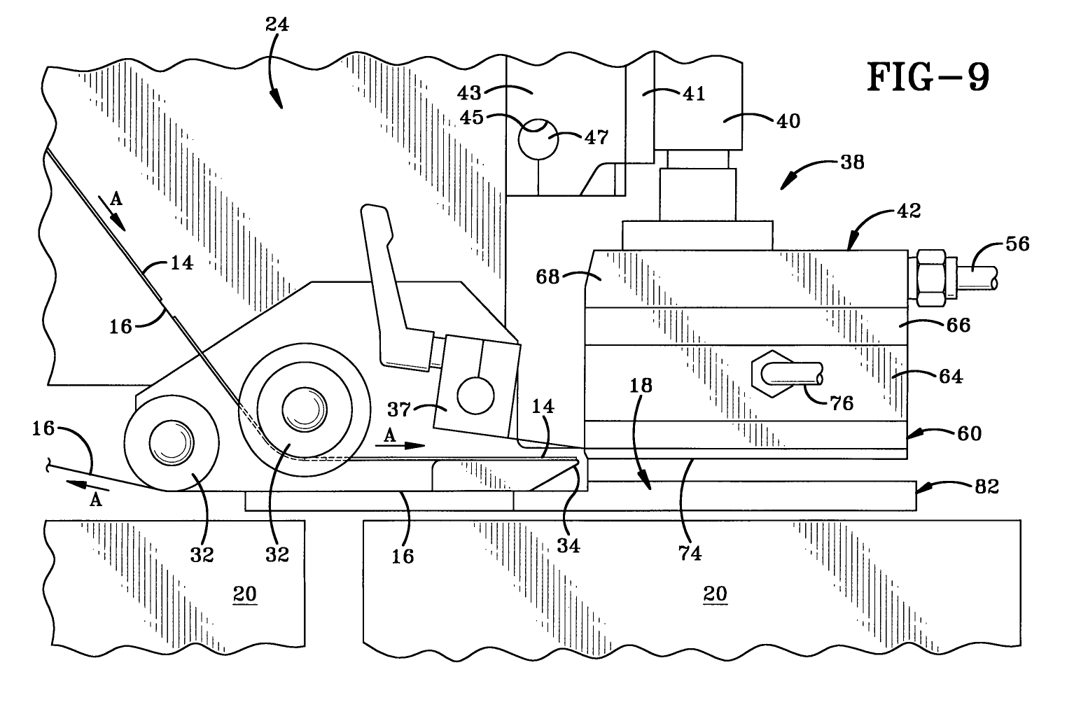

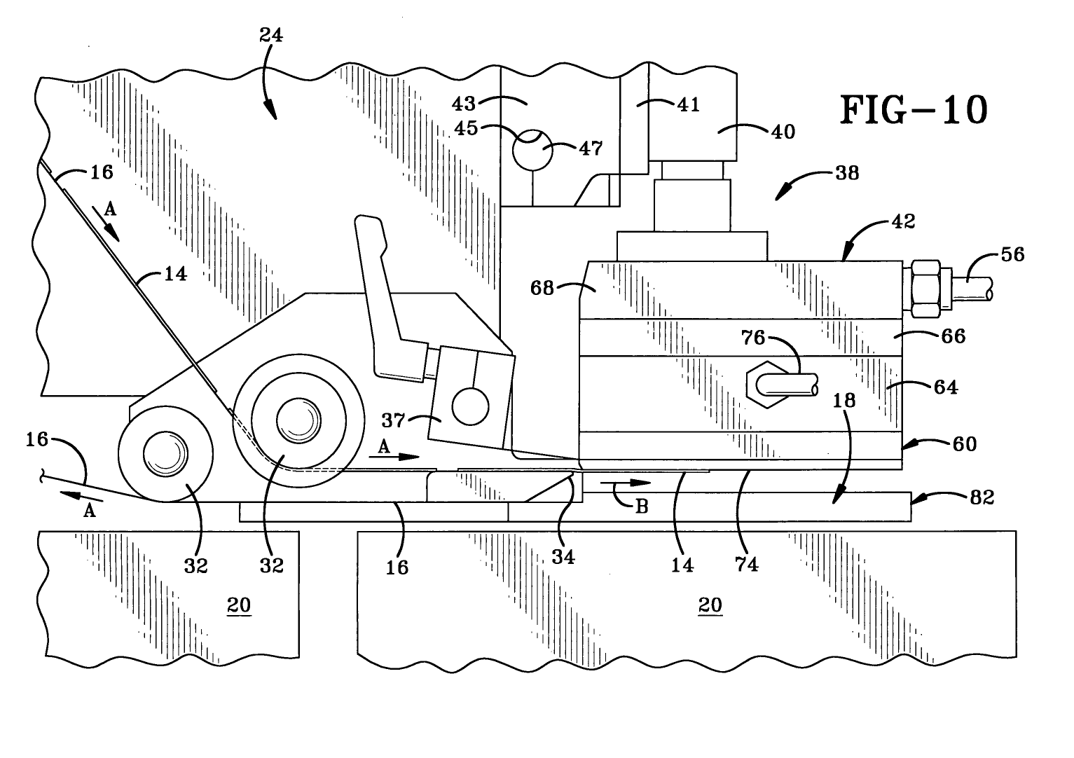

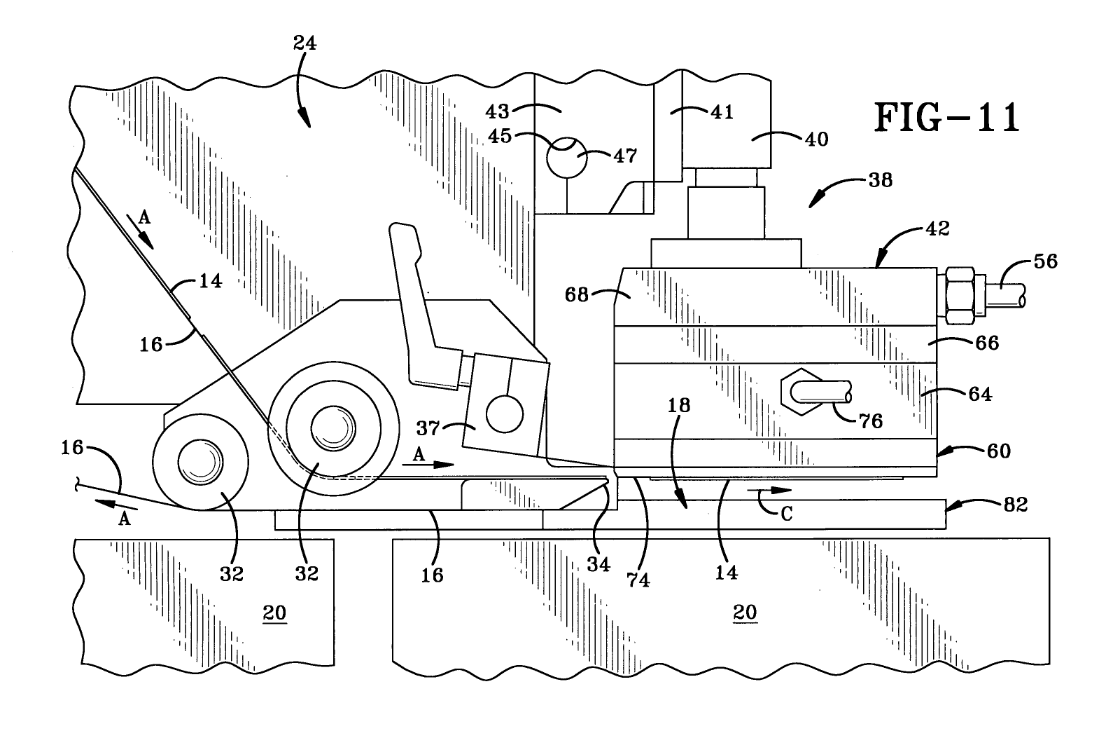

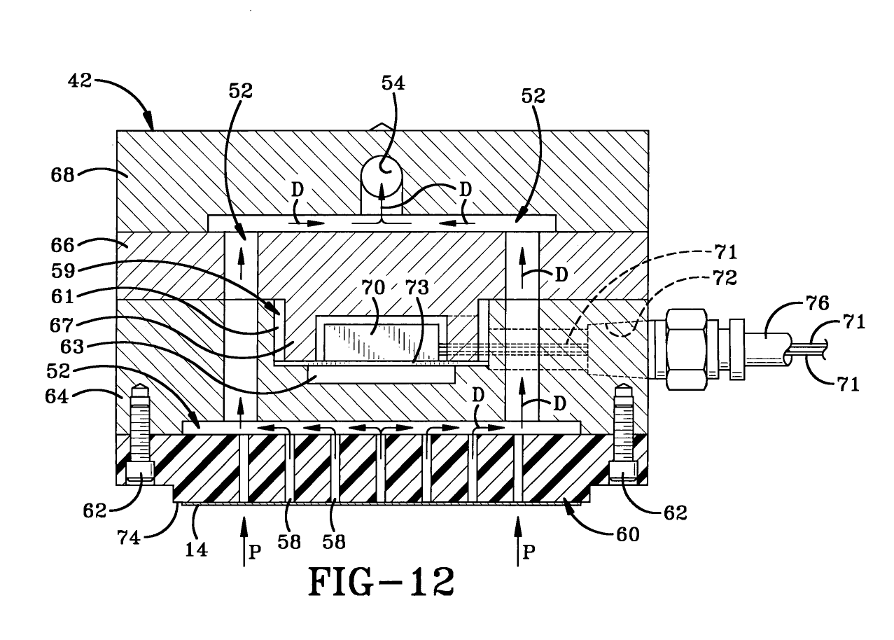

FIGS. 9-11 show a label 14 moving from carrier web 16 onto lower surface 74 of label pad 60. FIG. 9 shows a label 14 still disposed on carrier web 16 just prior to reaching peel edge 34. As carrier web 16 continues its travel toward rewind assembly 36 after a sharp turn around peel edge 34, label 14 begins to peel from carrier web 16 and moves in the direction indicated by Arrow B into application zone 18 beneath label pad 60, as shown in FIG. 10. As shown in FIG. 11, label 14 has continued to move in the direction indicated by Arrow C so that label 14 is disposed beneath and in contact with lower surface 74 of label pad 60, held there by suction as described below. Simultaneous with the advancement of label 14, items 20 advance on conveyor belt 22 so that an item 20 is positioned below application zone 18 in preparation for application of label 14 thereon. With reference to FIG. 12, Arrows labeled D show the direction of air flow through passageways 52 as controlled by valve bank assembly 57 to provide a suction effect whereby label 14 is moved upwardly as indicated by Arrows P and held in place on lower surface 74 of label pad 60 as noted before.

At this point, label 14 is disposed directly below RF antenna 70 whereby antenna 70 and reader/writer 79 are used in a reading mode to test the integrity of the transponder on label 14, including verification that there is a readable ID code on the transponder. Antenna 70 and reader/writer 79 may also be used in a writing mode to write information to the transponder on label 14 so as to provide information pertinent to item 20, as well as any other information that is desired. This transponder integrity check is made by the logic board test circuit of reader/writer 79 via antenna 70. If the logic board determines that a given label 14 is suitable or viable, label 14 may be applied as is to an item 20, or appropriate information may then be written onto label 14 via antenna 70 and label 14 then applied to item 20. If the logic board determines that label 14 is unsuitable or non-viable, label 14 is rejected, as detailed further below. Alternately, once information is written onto label 14, antenna 70 may also read the newly written information to ensure the viability thereof, that is, whether the information is readable and accurate. Logic board 79 determines whether the information on label 14 is viable. Labels 14 with viable information are applied to respective items 20 and labels 14 with non-viable information are rejected. Whether label 14 is to be applied or rejected, the logic board sends a signal via wires 71 to operate applicator 10 to that effect, the methods of application and rejection being described below.

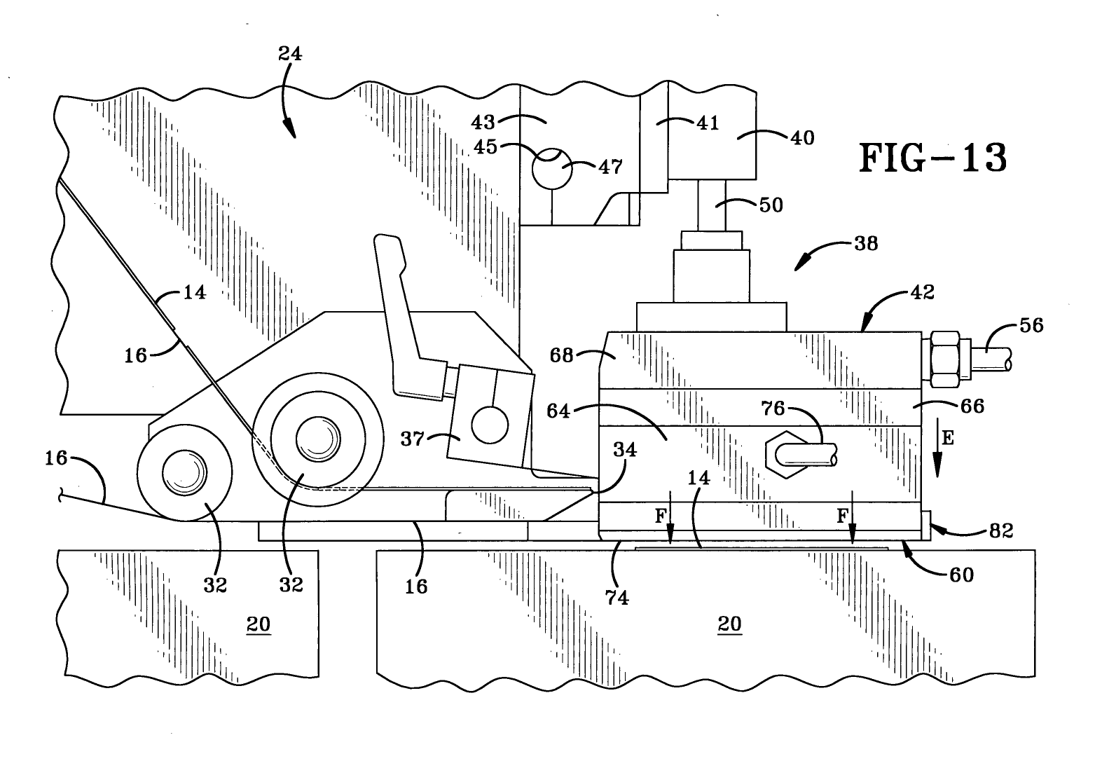

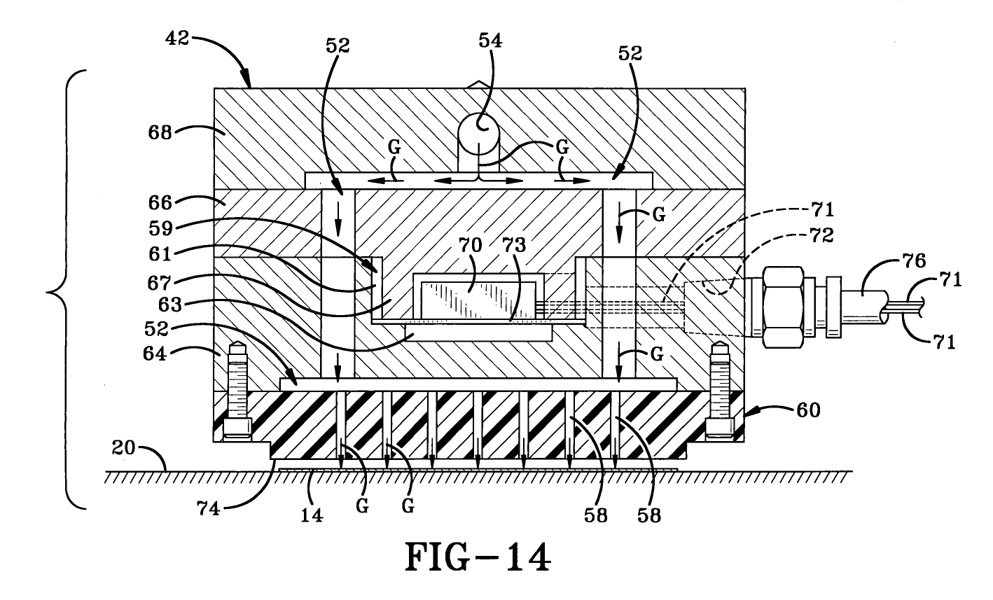

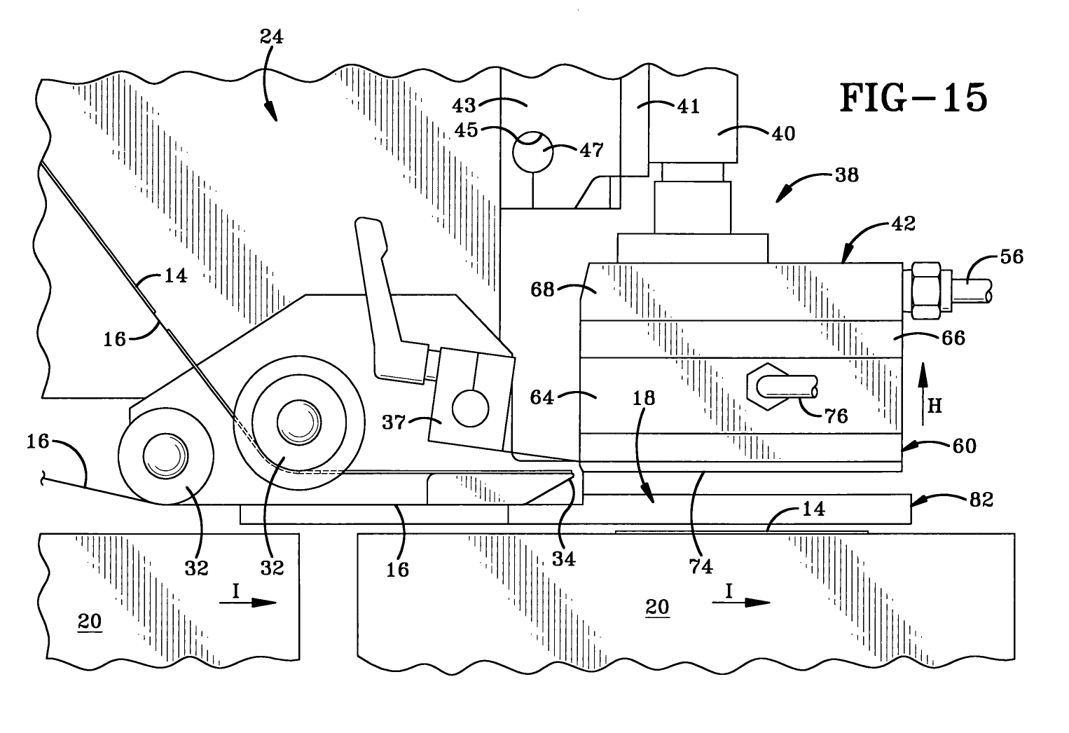

The application of label 14 onto item 20 may be accomplished in two ways by applicator 10. The first method is shown in FIGS. 13-15, and is known as the tamp and blow method. FIG. 13 shows pad assembly 42 moving downwardly in a direction indicated by Arrow E and label 14 subsequently being blown off of label pad 60 in the direction of Arrows F onto item 20. The downward movement of pad assembly 42 is accomplished by pneumatic actuation of piston-cylinder combination 44, whereby piston rod 48 extends downwardly along with guide bars 50, which help align the downward movement. This pneumatic actuation is driven by compressed air from source 53 via conduits 51 and 55 and valve bank assembly 57. The downward movement of label 14 away from label pad 60 is accomplished by reversal of the air flow through passageways 52, as shown in FIG. 14 by Arrows G. After label 14 is applied to item 20, tamp assembly 38 is operated in a reverse order so that pad assembly 42 is moved upwardly in the direction of Arrow H as shown in FIG. 15. In addition, after application of label 14, item 20 then moves along conveyor belt 22 in the direction of Arrow I as shown in FIG. 15 in order to allow a next item 20 to move into place below application zone 18 in preparation for application the next label 14.

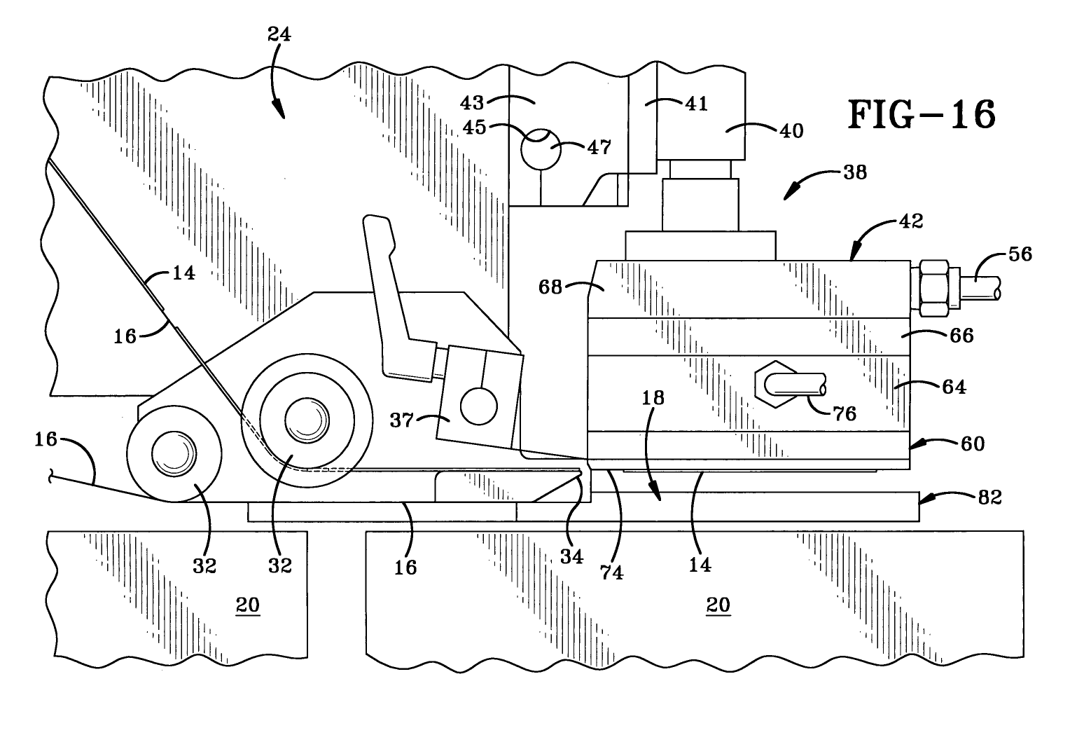

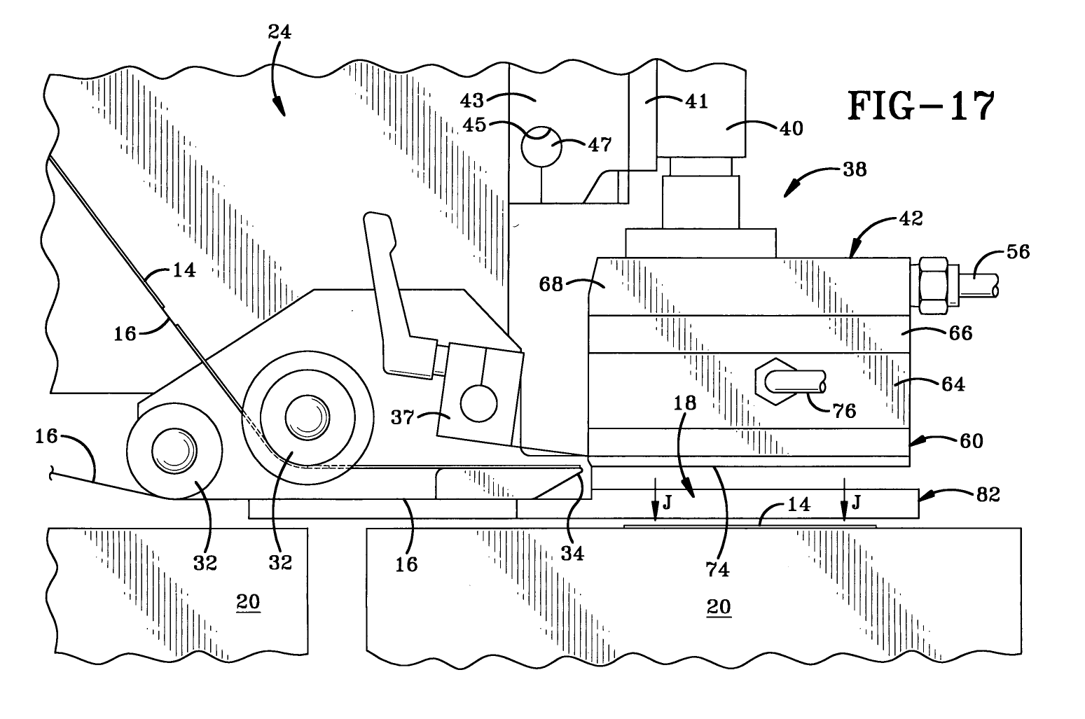

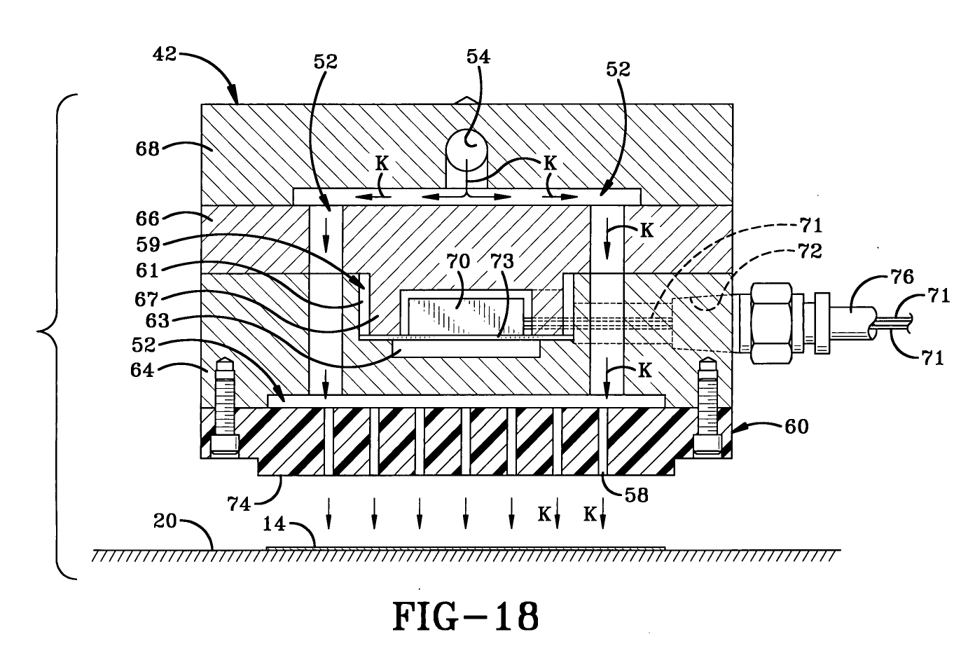

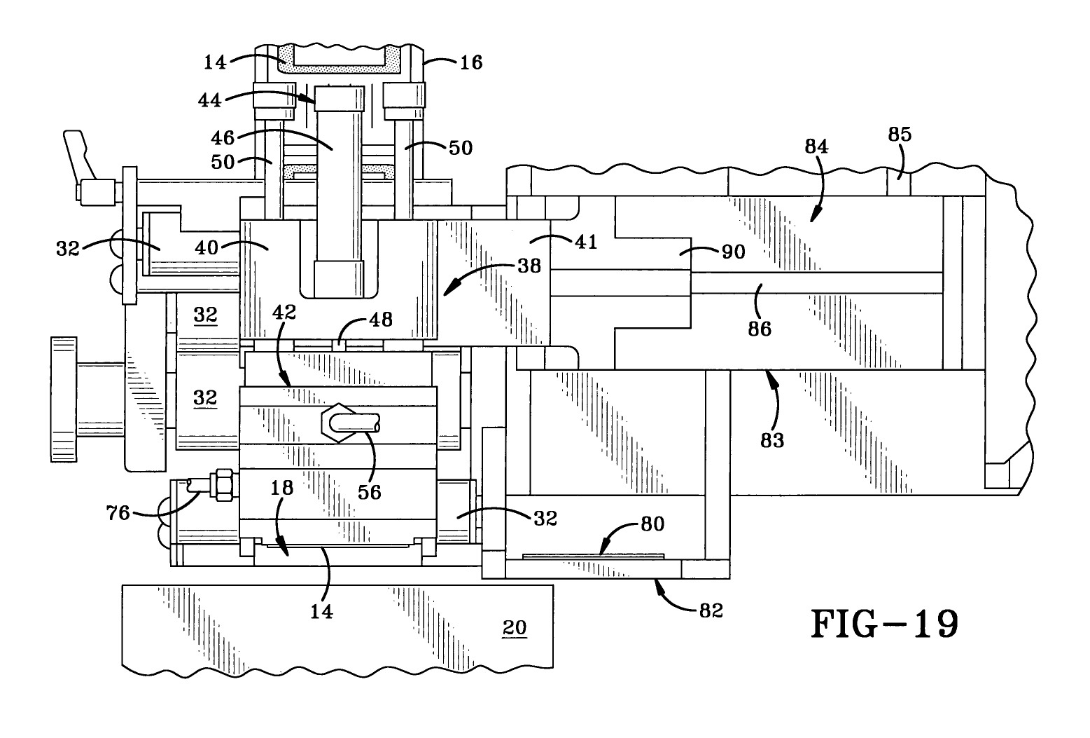

FIGS. 16-18 show an alternate method of applying label 14 to item 20. As shown in FIG. 16, a label 14 is disposed adjacent lower surface 74 of label pad 60 and held there by suction as previously described. In FIG. 17, label 14 is blown downwardly in the direction shown by Arrows J onto item 20. This method is known as the blow method. The air flow to accomplish the blow method of applying label 14 to item 20 is shown in FIG. 18 in the direction of Arrows K. The blow method differs from the tamp and blow method in eliminating the tamping step whereby the head or pad assembly 42 is moved toward item 20 prior to the label being blown off of pad 60. Thus, the blow method is achieved while pad assembly 42 remains in the raised position.

In accordance with another main feature of the present invention, the rejection process of a rejected label 14 is shown in FIGS. 19-21. FIG. 19 shows a label 14 positioned above an item 20, the label 14 having been determined to be a reject label by reader/writer 79 logic board via antenna 70. Once this determination has been made, pad assembly 42 and tamp assembly 38 slide with slide plate 90 and guide bars 47 along slide mount 84 from the home position shown in FIG. 19 to a rejection position shown in FIG. 20 situated above reject label platform 82, pad assembly 42 and related moving members having slid in the direction of Arrow L shown in FIG. 20. As also shown in FIG. 20, the reject label 14 is then deposited on rejection location 80, moving downwardly in the direction indicated by Arrows M. As shown in FIG. 21, after reject label 14 has been deposited in rejection location 80, pad assembly 42 and tamp assembly 38 are moved back to the home position along the path indicated by Arrows N. At this point, applicator 10 is ready to test another label 14 and make the determination whether to reject the label or write information to the label and apply it to an item 20 should the label be acceptable.

Applicator 10 provides an important advancement in label application, particularly in the testing of RFID labels 14 prior to their application to an item 20 so that problems associated with applying a bad label to an item 20 are avoided, those problems having been discussed in the background portion of this application. This is a substantial step in the advancement of quality control of the overall process related to the labeling of various items, in particular items moving through the marketplace which need to be tracked and have readable information at every stage of shipping, receiving, storage, inventory control and ultimately at the final stage of purchasing an item in the marketplace. Labels 14 may have encoded price information or an identification code which can be related to a price within a given store. Thus, the impact of controlling the quality of the labels at the application stage is a very important tool having far-reaching implications throughout the marketing process.

A variety of changes can be made to applicator 10 without departing from the spirit of the invention. For instance, the tamp assembly and the slide assembly may each slide via different mechanisms. For example, they may be hydraulically or electrically powered or may use ball screws or other suitable mechanisms. It is also contemplated that pad assembly 42 and tamp assembly 38 could slide in a different direction than is indicated in the figures of the exemplary embodiment. In addition, it is further contemplated that tamp assembly 42 could be rotated or otherwise moved in order to accomplish the movement necessary to dispose of a reject label. It is also contemplated that antenna 70 could be positioned somewhat differently, for example, being mounted externally on pad assembly 42. Further, antenna 70 may be mounted separately from pad assembly 42 so that it is positioned to read and write to RFID labels and whereby it would not move with label pad 60 to a rejection position. For example, the RF antenna may be positioned adjacent the labels prior to the labels separating from the carrier web. In addition, reader/writer 79 may be located virtually anywhere on applicator 10 as long as it remains in communication with antenna 70, which is a simple matter of wiring. Also, wires 71 may be otherwise routed, for example, through manifold section 68 and so forth.

As previously noted, items to be labeled are typically conveyed to the application zone by a conveyor belt. However, this may be achieved in a wide variety of ways. For instance, a forum speed table may be involved or a robot may move items to the application zone. Alternately, a vertical lift or an escalator-type conveyor may be used. Other conveyance means will be evident to those skilled in the art.

It is further contemplated that the invention may be adapted for use with an applicator using the merge method of label application. In use with the merge method, the antenna would test a label while still on the carrier web and either apply the label if viable or reject the label if non-viable. Writing to a viable label may also occur while the label is still on the carrier web. An applicator head capable of suctioning the label could be used with the merge method in order to remove a non-viable label and move it to a reject location in a similar fashion as shown and described above. Alternately, for example, non-viable labels could merge onto a movable label interceptor instead of the product so that the interceptor could move the label to a reject location.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An applicator for applying RFID labels of the type having a transponder, the applicator comprising:
an application zone;
an applicator head positioned adjacent the application zone and adapted for applying the label to a product;
an antenna positioned adjacent the application zone and adapted for reading the transponder;
a test circuit for receiving information from the antenna and adapted to determine if the transponder is viable; and
a reject area adapted for receiving rejected labels from the applicator head if the test circuit determines that there is a non-viable transponder.

2. The applicator of claim 1 wherein the reject area is separate from the application zone.

3. The applicator of claim 2 wherein the applicator head is movable between a home position adjacent the application zone and a reject position adjacent the reject area.

4. The applicator of claim 3 further comprising a slide rail on which the applicator head is slidably movable between the home and reject positions.

5. The applicator of claim 4 further comprising a pneumatic power supply for moving the head from the home position to the reject position.

6. The applicator of claim 4 wherein a tamp assembly is attached to the slide rail and a label pad is connected to the tamp assembly.

7. The applicator of claim 6 further comprising a movement device carried by the tamp assembly and adapted for moving the applicator head toward the product.

8. The applicator of claim 3 further comprising air channels formed within the applicator head.

9. The applicator of claim 8 wherein the air channels are connected to an air source capable of at least one of moving air from the air source into the air channels and moving air from the air channels toward the air source.

10. The applicator of claim 1 wherein the applicator head defines air channels through which air is movable to blow the labels onto the product.

11. The applicator of claim 10 further including a tamp assembly for moving the applicator head toward the product to facilitate blowing the label onto the product.

12. The applicator of claim 3 further including a peel edge for separating labels from a carrier web, the peel edge being disposed adjacent the applicator head when in the home position; a suctioning mechanism to hold the label against the applicator head; and a blowing mechanism to blow the label onto the product if the transponder is viable and to blow the label to the reject area if the transponder is non-viable.

13. The applicator of claim 1 wherein the antenna is adapted to write information to the transponder; wherein the test circuit is adapted to determine if the information written to the transponder is viable; and wherein the reject area is adapted for receiving rejected labels from the applicator head if the test circuit determines that there is non-viable information on the transponder.

14. The applicator of claim 1 wherein the applicator head includes a label pad and wherein the antenna is positioned adjacent the label pad.

15. The applicator of claim 14 wherein the antenna is carried by the applicator head.

16. The applicator of claim 15 wherein the antenna is positioned above the label pad within the applicator head.

17. The applicator of claim 16 further comprising air channels formed within the applicator head.

18. The applicator of claim 17 wherein the air channels are connected to an air control capable of at least one of moving air from the air control into the air channels and moving air from the air channels toward the air control.

19. The applicator of claim 18 wherein the air channels extend around the antenna on at least one side within the applicator head.

20. A method of applying an RFID label to an item, the label having a transponder, the method comprising the steps of:
positioning a label adjacent an application zone;
testing the label for viability adjacent the application zone;
communicating the result of the test to a control circuit;
allowing the control circuit to communicate with a power supply; and
operating the power supply to move the label to the item if the label is viable.

21. The method of claim 20 further including the step of operating an RFID antenna adjacent the application zone to test the viability of the label.

22. The method of claim 21 wherein the label is tested when the label is positioned at least partially on an applicator head.

23. The method of claim 22 wherein the testing step includes coupling the antenna electronically to the label through at least a portion of the applicator head.

24. The method of claim 21 further comprising the step of writing to the label after the test has confirmed a viable label.

25. The method of claim 24 further comprising the steps of testing information written to the label for viability of the information and applying the label to the item if the information is viable and moving the label to a reject area if the information is non-viable.

26. The method of claim 21 further comprising the step of moving the label to a reject area if the test reveals that the label is non-viable.

27. The method of claim 26 wherein the moving step includes sliding an applicator head carrying the label from a position adjacent the application zone to a position adjacent the reject area.

28. The method of claim 21 wherein the antenna is mounted within the applicator head; wherein at least one air channel is formed in the applicator head and extends around the antenna; and wherein the method further includes the step of evacuating air from the at least one air channel after the test is complete.

29. The method of claim 20 wherein the operating step includes the step of blowing the label to move the label to the item if the label is viable.

30. The method of claim 29 wherein the blowing step includes operating an air source to move air through air channels formed in an applicator head.

31. The method of claim 29 further including the step of moving the applicator head toward the item prior to the blowing step.

32. The method of claim 30 wherein the operating step includes suctioning the label to the applicator head prior to the blowing step.

33. The method of claim 32 further including the step of guiding a carrier web carrying the label around a peel edge adjacent the applicator head to separate the label from the carrier web prior to the suctioning step.

34. A method of applying an RFID label to an item, the label having a transponder, the method comprising the steps of:
positioning a label adjacent an application zone;
testing the label for viability adjacent the application zone with an RFID antenna; and
moving the label to the item if the label is viable and to a reject area if the label is non-viable.

35. The method of claim 34 further comprising the step of writing to the label after the test has confirmed a viable label.

36. The method of claim 35 further comprising the steps of testing information written to the label for viability of the information and applying the label to the item if the information is viable and moving the label to the reject area if the information is non-viable.

37. The method of claim 34 wherein the moving step includes the step of blowing the label to move the label to the item if the label is viable and blowing the label to move the label to the reject area if the label is non-viable.

38. The method of claim 37 wherein the moving step includes sliding an applicator head carrying the label by suction from a home position adjacent the application zone to a reject position adjacent the reject area if the label is non-viable.
